(19) United States
(12) Patent Application Publication
(10) Pub. No.: US 2006/0263746 A1
(43) Pub. Date: Nov. 23, 2006

(54) Drill for operating implant

(76) Inventors: Kwang Bum Park, Daeku (KR); Seok Kyu Choi, Pusan (KR); Kyoung Ho Ryoo, Kwangjoo (KR)

Correspondence Address: MCCARTER & ENGLISH, LLP, FOUR GATEWAY CENTER, 100 MULBERRY STREET, NEWARK, NJ, 07102, US

(21) Appl. No.: 11/438,008

(22) Filed: May 19, 2006

(30) Foreign Application Priority Data
May 20, 2005 (KR) 20-2005-0014304
Jun. 21, 2005 (KR) 10-2005-0053478

(51) Int. Cl. A61C 3/02

(52) U.S. Cl. 433/165

(57) ABSTRACT

Disclosed herein is a drill for operating implant which allows a user to easily check abrasion of a drill blade with naked eyes. The drill for operating implant includes: a drill body; a drill blade formed on the drill body for perforating an implantation place of the implant when the drill body is rotated; and, an abrasion discrimination part formed at least one of the drill body or the drill blade for allowing a user to discriminate abrasion of the drill blade.

### CROSS-REFERENCE TO RELATED APPLICATION

This application claims the priority of Korean Utility Model Application No. 20-2005-0014304 filed May 20, 2005 and Korean Patent Application No. 10-2005-0053478 filed Jun. 21, 2005, the disclosures of which are incorporated herein by reference in their entirety for all purposes.

### BACKGROUND OF THE INVENTION

1. Field of the Invention

The present invention relates to a drill for operating implant, and more particularly, to a drill for operating implant which allows a user to easily check abrasion of a drill blade with naked eyes.

2. Background Art

In general, implant means a substitute for recovering a lost or damaged human tissue when the human tissue is lost or damaged, but means transplantation of an artificial tooth in the dental surgery. The implant is the latest technology for recovering functions of teeth by fixing the artificial tooth after an artificial root, which is made of titanium and does not cause rejection to a human body, is implanted into a bone where the real tooth came out, in stead of a real root of a lost tooth. Prostheses or false teeth damage other teeth and bones around the prostheses or the false teeth as time goes by, but the implant can be used semi-permanently since it does not damage teeth tissues around the implant, has the same functions and shape as natural teeth, and does not cause decay of teeth.

A surgical operation process of the artificial tooth includes the steps of perforating an implantation hole using a drill, implanting an implant into an alveolar bone for osteo-integration, joining an abutment to the implant, and covering the abutment with the final prosthesis.

Such implant not only recovers a single lost tooth but also promotes functions of dentures applied to a partially or completely missing teeth patient, provides an improved beautiful outward appearance in substitution and recovery of the teeth, disperses excessive stress applied to the bone around the implant, and is of help to stabilization of a set of teeth.

Meanwhile, the drill used for perforating the implantation hole before the implantation of the implant is made of stainless steel which is anti-corrosive. A drill blade is abraded when the drill is used several tens or hundreds times. If the drill having the abraded blade is used, heat is generated during drilling since the abraded blade meets resistance, so that the bone tissue is broken or damaged. When the bone tissue is broken or damaged, there is strong possibility that the implant operation ends in a failure. Occasionally, it makes the implant operation complicated. Therefore, to reduce such ill effects and increase efficiency in the implant operation, the abraded blade of the drill must be replaced with a new one in time.

However, it is very difficult to check with naked eyes whether or not the drill blade is abraded since the implant and the drill are very small. Furthermore, since it is difficult to check with naked eyes whether or not the blade of the drill is abraded, a user has to generally observe the drill blade after enlarging the blade part using a microscope, but it is very complicated and inconvenient to observe abrasion of the drill blade using the microscope every time.

### SUMMARY OF THE INVENTION

Accordingly, to solve the above disadvantages of the prior arts, it is an object of the present invention to provide a drill for operating implant which allows a user to easily check abrasion of a drill blade with naked eyes.

It is another object of the present invention to provide a drill for operating implant which allows the user to easily check replacement time of the drill, thereby increasing efficiency in implant operation, and reducing ill effects due to a use of an abraded drill.

It is a further object of the present invention to provide a drill for operating implant which prevents abrasion and does not cause rejection of drill chips to a human body even though the drill chips generated by the abrasion of the drill blade exist in the bone tissue.

To accomplish the above objects, according to the present invention, there is provided a drill for operating implant comprising: a drill body; a drill blade formed on the drill body for perforating an implantation place of the implant when the drill body is rotated; and an abrasion discrimination part formed on at least one of the drill body or the drill blade for allowing a user to discriminate abrasion of the drill blade.

Here, the abrasion discrimination part is coated on the outer periphery of the drill body or the drill blade and has one of various colors.

The abrasion discrimination part is formed by anodizing, and the color of the abrasion discrimination part is determined by voltage applied when it is anodized.

The drill body and the drill blade are made of titanium and formed integrally with each other.

The drill further comprises at least one implantation depth indicating pattern formed on the abrasion discrimination part for indicating an implantation depth of the implant.

It is preferable that the implantation depth indicating pattern is in the form of a band surrounding the outer periphery of the drill body and the drill blade.

A number of the implantation depth indicating patterns are formed along a longitudinal direction of the drill body from an end portion of the drill body at irregular intervals, and at least one of the implantation depth indicating patterns is wider than the other implantation depth indicating patterns.

A decolorized part is formed on at least one area of the abrasion discrimination part existing between the implantation depth indicating patterns.

The decolorized part is formed at an area spaced from the end portion of the drill body at a predetermined interval.

The implantation depth indicating pattern and the decolorized part are formed by laser processing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a brief sectional view showing a process of implanting an implant into an implantation place perforated using a drill for operating implant according to the present invention;

FIGS. 2 to 4 are views showing a manufacturing process of the drill for operating implant by steps;

FIG. 5a is photographs of the drill enlarged with a microscope for showing a state where color of the drill is exfoliated according to the number of drilling times; and

FIG. 5b is photographs of the drill of 3.3 mm in diameter for showing an abraded and decolorized state of the drill when the drill is used thirty times, fifty times, one hundred times, and one hundred-fifty times.

### DETAILED DESCRIPTION OF THE PREFERRED EMBODIMENT

Reference will be now made in detail to the preferred embodiment of the present invention with reference to the attached drawings.

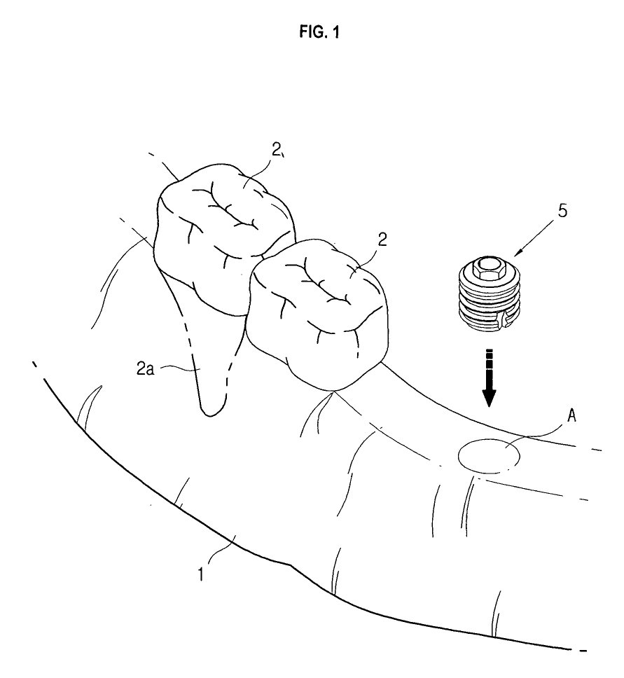

FIG. 1 is a brief sectional view showing a process of implanting an implant into an implantation place perforated using a drill for operating implant according to the present invention.

As shown in the drawing, a number of teeth 2 are arranged on gums 1. The teeth 2 are the first digestive means for finely breaking foods and sending them to the stomach and intestines, and the number of the teeth is generally 28, but it may differ from person to person.

If one tooth 2 of the teeth 2 is lost (loss of molar teeth part), a patient may have a dull sense of taste of foods and feel inconvenience in chewing foods. So, an implant 5 (also called ‘fixture’) is implanted into the gum 1 of the lost tooth 2 as means for substituting for a root 2a of the tooth 2. The implant 5 is made of titanium which has no rejection to a human body. The implant 5 can be manufactured by the prior art technology.

For implantation, first, an implantation hole (A) is perforated in an alveolar bone of the gum 1 of the lost tooth 2 using a drill 10. After that, the implant 5 is inserted into the implantation hole (A), implanted into the alveolar bone, and osteo-integrated to the bone. An abutment is joined to the implant 5, and then, covered with the final prosthesis.

As described above, for implantation of the implant 5, it is first necessary to perforate the implantation hole (A). The perforation of the implantation hole (A) is achieved by the drill 10. Meanwhile, if the drill 10 is used several tens or hundreds times, a drill blade 12 is abraded, and if the abraded state is severe, the drill blade must be replaced with a new one. However, as described above, in case of the prior art drill, a user cannot easily check abrasion of the drill blade 12 with naked eyes, and so, has to use a microscope. However, if the user uses the present invention having the following structural characteristics, the above problem can be easily solved.

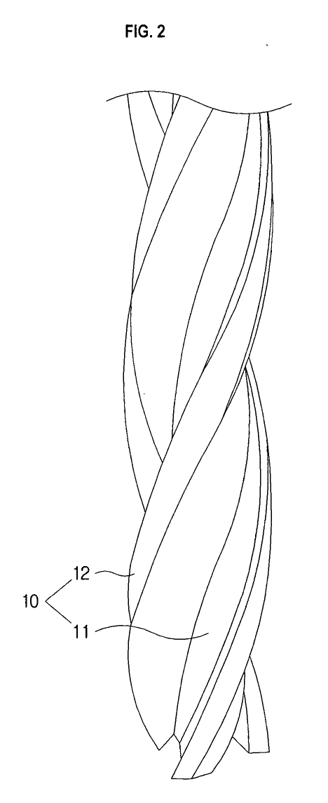

FIGS. 2 to 4 are views showing a manufacturing process of the drill for operating implant by steps.

As shown in the drawings, the drill 10 for operating implant according to the present invention includes: a drill body 11 forming a shaft; and the drill blade 12 formed on the outer periphery of the drill body 11 for perforating the implantation hole (A) of the implant 5 when the drill body 11 is rotated. The drill blade 10 is what is called a land, and manufactured integrally with the drill body 11. The drill 10 is generally made of stainless steel which is anti-corrosive. However, in the present invention, the drill 10 is made of titanium which is used as a material of the implant 5. The reason is that drill chips generated due to abrasion of the drill blade do not cause any problems even though they exist in a bone tissue since titanium is anti-corrosive and has no rejection to the human body.

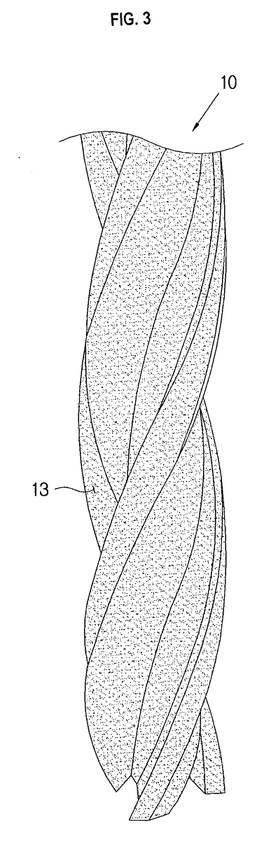

The drill 10 has an abrasion discrimination part 13 (hatched part in FIG. 3) formed on the outer periphery thereof as means for discriminating whether or not the drill blade 12 is abraded. The abrasion discrimination part 13 is coated on the outer periphery of the drill 10 in black and white or in one of various colors. So, according to an exfoliated level of the color coated on the drill 10, the user can easily check abrasion of the drill blade 12 with naked eyes through the abrasion discrimination part 13 while using the drill 10.

The abrasion discrimination part 13 can be easily formed by coating the outer periphery of the drill 10 with a desired color. The abrasion discrimination part 13 can be formed on the drill 10 by painting, but in this case, the painted color can be easily exfoliated. Therefore, a metal surface treatment is used as a method for preventing an easy exfoliation.

For the metal surface treatment, there are representatively plating and anodizing. The two treatment methods are used for preventing oxidation of metal. Plating is to protect the surface of metal by coating a metal film on the surface of metal, but has a disadvantage in that it is expensive since noble metal such as gold or silver is generally used.

However, the anodizing used in the present invention is a method for preventing progress of oxidation between the surface of metal and the outside oxygen by forming a thin oxide film on the surface of metal, and relatively inexpensive.

The anodizing is generally applied to materials for a car. Generally, aluminum materials are used to car components in order to make a car body light due to a fuel consumption ratio. However, the aluminum materials are fragile since the components get weak due to oxidation. Therefore, in order to prevent oxidation, the anodizing is applied to the aluminum materials to form a thin film. Moreover, a number of lightweight and gray-colored products such as pipes are made of anodized metal. The drill 10 of the present invention can be anodized since it is made of titanium.

So, the drill 10 made of titanium has the thin oxide film formed on the outer periphery thereof by anodizing. The final color formed by anodizing is determined by voltage applied during anodizing. That is, the color of the drill 10 is determined according to strength of voltage. Also, the implant 5 has a color to discriminate its size, and therefore, the color of the drill 10 can be selected in correspondence with the color of the implant 5. By the above, the user can discriminate the replacement time of the drill 10 by checking exfoliation of the color of the abrasion discrimination part 13 with naked eyes during the use of the drill 10. Therefore, the drill 10 can be replaced with a new one in time, so that damage of the bone tissue by heat generated during the use of the abraded drill 10 can be prevented.

Meanwhile, when the implantation hole (A) is perforated by the drill 10, an implantation depth is based on the length of the implant 5. Generally, the implant 5 of 10 mm or 11.5 mm is widely used. However, the implants 5 of 7 mm, 8.5 mm, 13 mm and 15 mm are sometimes used.

The drill 10 according to the present invention further includes implantation depth indicating patterns (P1˜P6) formed on the outer periphery thereof as means for indicating the implantation depth corresponding to the length of the implant 5. As described above, the implantation depth indicating patterns (P1˜P6) are in the form of a band surrounding the outer periphery of the drill 10, and formed by laser processing. For your reference, if titanium is laser-processed, white or black color is formed thereon, in this embodiment, the implantation depth indicating patterns (P1˜P6) have black-colored bands.

A number of the implantation depth indicating patterns (P1˜P6) are formed in a longitudinal direction of the drill 10 from an end portion of the drill 10 at irregular intervals. As described above, since the implants 5 may be 7 mm, 8.5 mm, 10 mm, 11.5 mm, 13 mm and 15 mm in length, six implantation depth indicating patterns (P1˜P6) are formed at positions corresponding to the lengths of the implants 5 from the end portion of the drill 10. That is, the implantation depth indicating patterns (P1˜P6) are formed in the black band shape at heights of 7 mm, 8.5 mm, 10 mm, 11.5 mm, 13 mm and 15 mm (H2˜H7) from the end portion of the drill 10.

At this time, the implantation depth indicating patterns (P1, P2, P5 and P6) are in the form of a thin band, but the implantation depth indicating patterns (P3 and P4) have the black bands wider than the other bands of the implantation depth indicating patterns (P1, P2, P5 and P6). That is, the black band is formed at an area between the implantation depth indicating patterns (P3 and P4) by the laser processing. The reason is that the implants of 10 mm and 11.5 mm are the most used. That is, since the area between the implantation depth indicating patterns (P3 and P4) is in the form of the wide black band, the user can easily discriminate it with naked eyes. Therefore, in the case where the implant of 10 mm is used, the implantation hole (A) is perforated from the wide black band to the line of P3. In the case where the implant of 11.5 mm is used, the implantation hole (A) is perforated to the line of P4 which is the start line of the wide black band. So, the user can easily carries out perforating work while exactly seeing the implantation place.

Meanwhile, since the drill 10 made of titanium is coated with one color by anodizing and has the implantation depth indicating patterns (P1˜P6) of the black band shape formed thereon at irregular intervals by the laser processing, it is not easy to exactly discriminate the implantation depth indicating patterns (P1˜P6) during drilling work.

Therefore, in the present invention, to more clearly show the implantation depth indicating patterns (P1˜P6), decolorized parts 15a˜15c are formed by decolorizing the abrasion discrimination parts 13 formed on several parts of the areas formed between the implantation depth indicating patterns (P1˜P6). Since the decolorized parts 15a˜15c show the original titanium color of the drill 10 as it is, the implantation depth indicating patterns (P1˜P6) with the black color can be more clearly shown. The decolorized parts 15a˜15c can be formed at any areas, but considering that the end portion of the drill 10 is more easily abraded than other areas of the drill 10, it is preferable that the decolorized parts 15a˜15c are formed at an area (height, the first height of 3 mm which will be described later) spaced from the end portion of the drill 10 at a predetermined interval. The decolorized parts 15a˜15c can be also formed by the laser processing.

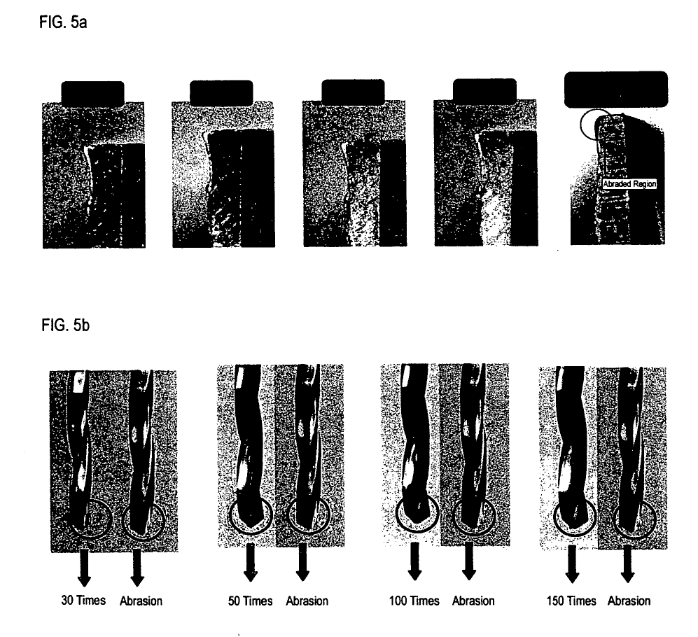

Referring to FIGS. 5a and 5b, the drill 10 of the present invention is decolorized according to the number of drillings, and used no longer due to abrasion of the blade when the drill blade 12 which is called a land is decolorized. In FIG. 5b, a photograph of the drill in which the word of ‘abraded’ is written shows the drill which cannot be used due to abrasion of the drill blade. Here, the drill is usable since the color of the drill is not completely exfoliated in spite of one hundred fifty times drilling.

Now, referring to FIGS. 2 to 4, a manufacturing process of the drill 10 according to the present invention will be described in series.

First, as shown in FIG. 2, the drill body 11 and the drill blade 12 are manufactured integrally using the titanium material. After that, as shown in FIG. 3, the drill 10 made of titanium is anodized. At this time, the entire area of the drill 10 can be anodized or only some area of the drill 10 shown in FIG. 3 can be anodized. It is assumed that the abrasion discrimination part 13 which is the blue oxide film is coated on the outer periphery of the drill 10 by anodizing.

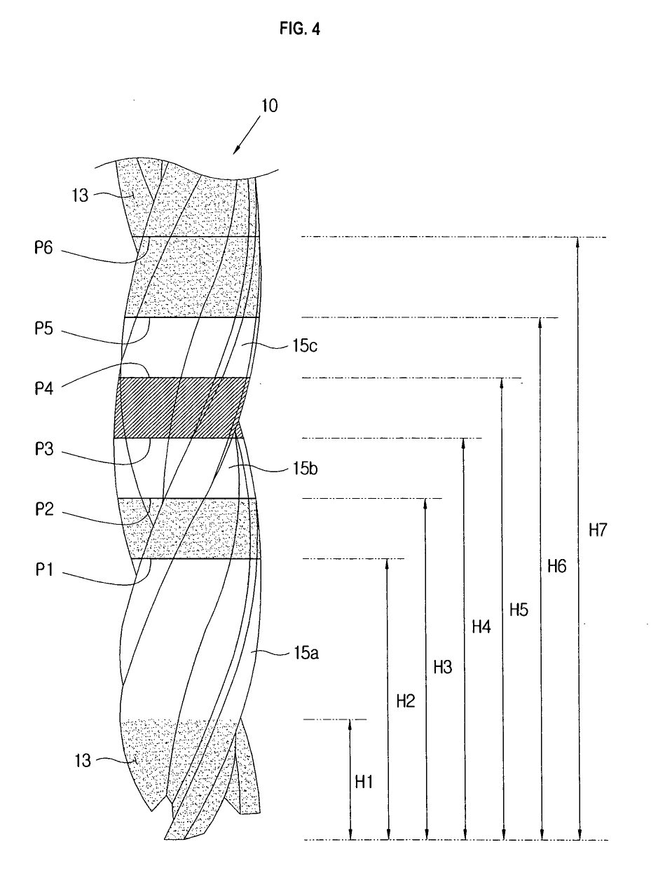

Next, as shown in FIG. 4, the abrasion discrimination part 13 is formed from the lower end of the drill 10 to the first height (H1, 3 mm). The reason is to more easily check abrasion of the drill 10 since abrasion occurs the most in the above area. The decolorized part 15a is formed from the first height (H1, 3 mm) to the second height (H2, 7 mm) by decolorization through the laser processing. Then, in this area, the blue oxide film is removed, and the original titanium color is exposed.

After that, at the second height (H2, 7 mm) and the third height (H3, 8.5 mm), the implantation depth indicating patterns P1 and P2 of the black bands are formed by the laser processing. The implantation depth indicating patterns P1 and P2 are to set the implantation depths corresponding to the lengths of the implants of 7 mm and 8.5 mm. The abrasion discrimination part 13 which is the oxide film formed between the second height (H2, 7 mm) and the third height (H3, 8.5 mm) is not decolorized.

After that, the implantation depth indicating patterns P3 and P4 of the wide bands formed by the laser processing are formed in the area between the fourth height (H4, 10 mm) and the fifth height (H5, 11.5 mm). This area is formed wide since the implants 5 of 10 mm and 11.5 mm are used the most.

To more clearly show the wide implantation depth indicating patterns P3 and P4, the decolorized parts 15b and 15c are respectively formed between the third height (H3, 8.5 mm) and the fourth height (H4, 10 mm) and between the fifth height (H5, 11.5 mm) and the sixth height (H6, 13 mm) by the laser processing, and the implantation depth indicating patterns P3 and P4 are located between the decolorized parts 15b and 15c. That is, the decolorized parts 15b and 15c have the original titanium color.

After that, in consideration of the implants 5 of 13 mm and 15 mm, the implantation depth indicating patterns P5 and P6 of the black band shape are respectively formed at the sixth height (H6, 13 mm) and the seventh height (H7, 15 mm) by the laser processing. The abrasion discrimination part 13 which is the oxide film formed between the sixth height (H6, 13 mm) and the seventh height (H7, 15 mm) is not decolorized.

After the drill 10 is manufactured by the above method, the user repeatedly uses the drill 10 for perforating the implantation hole (A) indicated in FIG. 1. When the abrasion discrimination parts 13 formed on the outer periphery of the drill 10, particularly, the drill blade 12, is abraded and decolorized as much as it is usable no more, the user replaces the drill 10 with a new one after easily checking abrasion of the drill blade 12 with naked eyes.

As described above, according to the present invention, the user can easily check abrasion of the drill blade 12 with naked eyes. Furthermore, the present invention increases efficiency in operation of the implant 5 and reduces ill effects in operation caused due to use of the abraded drill 10, since the user can easily check the replacement time of the drill 10.

In this embodiment of the present invention, the entire area formed between the implantation depth indicating patterns P3 and P4 is black by the laser processing, but the implantation depth indicating patterns P3 and P4 may be formed in a thin band like the other implantation depth indicating patterns.

The heights indicated in this embodiment are just examples, and so, the heights and lengths of the implants 5 can be changed according to circumstances.

As described above, the drill for operating implant according to the present invention the user to easily check abrasion of a drill blade with naked eyes.

Moreover, the drill of the present invention allows the user to easily check replacement time of the drill, thereby increasing efficiency in implant operation, and reducing ill effects due to the use of the abraded drill.

In addition, the drill of the present invention prevents abrasion and does not cause rejection of drill chips to a human body even though the drill chips generated by the abrasion of the drill blade exist in the bone tissue.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A drill for operating implant, comprising:
a drill body;
a drill blade formed on the drill body for perforating an implantation place of the implant when the drill body is rotated; and
an abrasion discrimination part formed on at least one of the drill body or the drill blade for allowing a user to discriminate abrasion of the drill blade.

2. A drill for operating implant according to claim 1, wherein the abrasion discrimination part is coated on the outer periphery of the drill body or the drill blade and has one of various colors.

3. A drill for operating implant according to claim 2, wherein the abrasion discrimination part is formed by anodizing, and the color of the abrasion discrimination part is determined by voltage applied when it is anodized.

4. A drill for operating implant according to claim 1, wherein the drill body and the drill blade are made of titanium and formed integrally with each other.

5. A drill for operating implant according to claim 1, further comprising at least one implantation depth indicating pattern formed on the abrasion discrimination part for indicating an implantation depth of the implant.

6. A drill for operating implant according to claim 5, wherein the implantation depth indicating pattern is in the form of a band surrounding the outer periphery of the drill body and the drill blade.

7. A drill for operating implant according to claim 6, wherein a number of the implantation depth indicating patterns are formed along a longitudinal direction of the drill body from an end portion of the drill body at irregular intervals, and at least one of the implantation depth indicating patterns is wider than the other implantation depth indicating patterns.

8. A drill for operating implant according to claim 7, wherein a decolorized part is formed on at least one area of the abrasion discrimination part existing between the implantation depth indicating patterns.

9. A drill for operating implant according to claim 8, wherein the decolorized part is formed at an area spaced from the end portion of the drill body at a predetermined interval.

10. A drill for operating implant according to claim 8, wherein the implantation depth indicating pattern and the decolorized part are formed by laser processing.

11. A drill for operating implant according to claim 2, further comprising at least one implantation depth indicating pattern formed on the abrasion discrimination part for indicating an implantation depth of the implant.

12. A drill for operating implant according to claim 3, further comprising at least one implantation depth indicating pattern formed on the abrasion discrimination part for indicating an implantation depth of the implant.

13. A drill for operating implant according to claim 4, further comprising at least one implantation depth indicating pattern formed on the abrasion discrimination part for indicating an implantation depth of the implant.
